(19) United States
(12) Patent Application Publication
(10) Pub. No.: US 2023/0382189 A1
(43) Pub. Date: Nov. 30, 2023

(54) SPLIT HEATER APPARATUS AND METHOD OF MANUFACTURING THE SAME

(71) Applicants: HYUNDAI MOTOR COMPANY, SEOUL (KR); KIA CORPORATION, SEOUL (KR)

(72) Inventors: Jae Sik Choi, Suwon-si (KR); Young Tae Song, Gwangmyeong-si (KR); Byeong Moo Jang, Suwon-si (KR); Dong Won Yeon, Hwaseong-si (KR); Sung Hwan Kim, Yongin-si (KR); Sung Young Lee, Yongin-si (KR); Byung Guk An, Asan-si (KR)

(21) Appl. No.: 17/972,131

(22) Filed: Oct. 24, 2022

(30) Foreign Application Priority Data
May 26, 2022 (KR) 10-2022-0064691

(51) Int. Cl. B60H 1/22; H05B 3/06; F24H 3/04

(52) U.S. Cl. CPC B60H 1/2225; H05B 3/06; B60H 1/2218; F24H 3/0441; H05B 2203/005; H05B 2203/016; H05B 2203/017

(57) ABSTRACT

The present disclosure provides a split heater apparatus and a method of manufacturing the same, the split heater apparatus being capable of dividing a heating region into zones, heating the zones individually, and having components capable of being simply assembled, such that the number of components and the number of assembly processes are reduced.

### CROSS REFERENCE TO RELATED APPLICATIONS

The present application claims priority to Korean Patent Application No. 10-2022-0064691, filed May 26, 2022, the entire contents of which is incorporated herein for all purposes by this reference.

### BACKGROUND

### Field

The present disclosure relates to a split heater apparatus and a method of manufacturing the same, the split heater apparatus being capable of dividing a heating region into zones, heating the zones individually, and having components capable of being simply assembled, such that the number of components and the number of assembly processes are reduced.

### Description of the Related Art

The electric vehicle operates using a motor that outputs power by being supplied with electricity from a battery. Because the electric vehicle emits no carbon dioxide, generates very low noise, and uses the motor with energy efficiency higher than energy efficiency of an engine, the electric vehicle is in the limelight as an environmentally friendly vehicle.

A key technology for implementing the electric vehicle is related to a battery module. Recently, studies have been actively conducted on a reduction in weight of a battery, a reduction in size of the battery, and a reduction in time taken to charge the battery. The battery module needs to be used in an optimal temperature environment to maintain an optimal performance and a long lifespan. However, the battery module is difficult to use in the optimal temperature environment because of a change in outside temperature and heat generated while the battery module operates.

In addition, because the electric vehicle emits no waste heat, which is generated during combustion in a separate internal combustion engine, the electric vehicle uses an electric heating device to heat the vehicle interior in the winter season. Further, because the electric vehicle needs to be warmed up, under a cold weather condition, to improve the performance of charging and discharging battery, the electric vehicle uses a separate electric heater that heats a coolant.

In addition, a separate PTC heater is further provided to satisfy a heat source required to heat the vehicle interior. However, the temperature control is performed by dividing the vehicle interior, such as regions of a driver seat, a passenger seat, and a rear seat, into zones at the time of performing the air conditioning on the vehicle interior, and the PTC heater is configured to be heated as a whole. For this reason, it is difficult to heat the zones individually. Further, in the case of the PTC heater in the related art, PTC elements and heat radiating fins need to be alternately assembled, which may increase the number of components and the number of assembly processes. In addition, because integrated silicone injection molding is applied to insulate a high-voltage terminal, the smell of silicone rubber is produced when a temperature of a heat generating portion is raised, which causes displeasure.

The foregoing explained as the background is intended merely to aid in the understanding of the background of the present disclosure, and is not intended to mean that the present disclosure falls within the purview of the related art that is already known to those skilled in the art.

### SUMMARY

The present disclosure is proposed to solve these problems and aims to a split heater apparatus and a method of manufacturing the same, the split heater apparatus being capable of dividing a heating region into zones, heating the zones individually, and having components capable of being simply assembled, such that the number of components and the number of assembly processes are reduced.

An exemplary embodiment of the present disclosure provides a split heater apparatus including a heat radiating unit including a frame configured to accommodate a plurality of heat generating elements, and a heat radiating plate configured to radiate the heat generated by the heat generating elements, and electrode plates respectively joined to two opposite surfaces of the frame and configured to apply power to allow the heat generating element to generate the heat, in which the electrode plates includes a first electrode plate disposed at one side of the heat generating elements and configured to adjoin all the plurality of heat generating elements, and a plurality of second electrode plates disposed at the other side of the heat generating elements and separated to adjoin some of the heat generating elements for respective heating regions.

The heat radiating unit may be configured such that the frame and the heat radiating plate are integrated, and the frame may be embedded in the heat radiating plate.

The frame may have a plurality of seating holes opened at two opposite sides thereof and configured such that the heat generating elements are seated in the plurality of seating holes, and the seating holes may be separated for the respective heating regions and have height deviations.

The split heater apparatus may further include insulation members configured to respectively adjoin outer sides of the first and second electrode plates and insulate the first and second electrode plates.

The heat radiating plate may include a first heat radiating plate, and a second heat radiating plate, the first heat radiating plate may include a first accommodation portion disposed at one side of the frame and configured to accommodate a part of the frame and the first electrode plate, and a first heat radiating part extending from the first accommodation portion and having a plurality of first vent holes, and the second heat radiating plate may include a second accommodation portion disposed at the other side of the frame and configured to accommodate a part of the frame and the second electrode plate, and a second heat radiating part extending from the second accommodation portion and having a plurality of second vent holes.

The first and second heat radiating plates may be separately coupled with respect to the frame and the electrode plate.

The first and second vent holes may be alternately disposed when the first and second heat radiating plates are coupled to each other.

The first heat radiating plate may include a plurality of first accommodation portions and a plurality of first heat radiating parts that are alternately disposed, the second heat radiating plate may include a plurality of second accommodation portions and a plurality of second heat radiating parts that are alternately disposed, and the frames and the electrode plates may be accommodated in the first and second accommodation portions when the first and second heat radiating plates are coupled.

The first and second heat radiating plates may have a plurality of heating zones as power is applied to the respective second electrode plates individually.

The split heater apparatus may further include a control module connected to the first and second electrode plates, and configured to determine whether to apply power.

Another exemplary embodiment of the present disclosure provides a method of manufacturing the split heater apparatus, the method including a first step of assembling a first electrode plate to one side of a frame, a second step of coupling a plurality of heat generating elements to the frame by applying an adhesive, a third step of assembling a plurality of second electrode plates to the other side of the frame, a fourth step of pressing the first electrode plate, the second electrode plate, and the heat generating elements against the frame and curing the adhesive, and a fifth step of attaching insulation members to outer surfaces of the first and second electrode plates.

The split heater apparatus and the method of manufacturing the same structured as described above may divide the heating region into the zones, heat the zones individually, and have the components capable of being simply assembled, such that the number of components and the number of assembly processes are reduced.

### BRIEF DESCRIPTION OF THE FIGURES

FIG. 1 is a view illustrating a split heater apparatus according to the present disclosure.

FIG. 2 is a view illustrating a frame and an electrode plate of the split heater apparatus illustrated in FIG. 1.

FIG. 3 is an exploded view of the split heater apparatus illustrated in FIG. 1.

FIG. 4 is a cross-sectional view of the split heater apparatus illustrated in FIG. 1.

FIG. 5 is a view illustrating a first heat radiating plate and a second heat radiating plate of the split heater apparatus illustrated in FIG. 1.

FIG. 6 is a view for explaining a first step of a method of manufacturing the split heater apparatus.

FIG. 7 is a view for explaining a second step of the method of manufacturing the split heater apparatus.

FIG. 8 is a view for explaining a third step of the method of manufacturing the split heater apparatus.

FIG. 9 is a view for explaining fourth and fifth steps of the method of manufacturing the split heater apparatus.

### DETAILED DESCRIPTION

Hereinafter, a split heater apparatus and a method of manufacturing the same according to an exemplary embodiment of the present disclosure will be described with reference to the accompanying drawings.

Specific structural or functional descriptions of embodiments of the present disclosure disclosed in this specification or application are exemplified only for the purpose of explaining the embodiments according to the present disclosure, the embodiments according to the present disclosure may be carried out in various forms, and it should not be interpreted that the present disclosure is limited to the embodiments described in this specification or application.

Because the embodiments according to the present disclosure may be variously changed and may have various forms, specific embodiments will be illustrated in the drawings and described in detail in the present specification or application. However, the descriptions of the specific embodiments are not intended to limit embodiments according to the concept of the present disclosure to the specific embodiments, but it should be understood that the present disclosure covers all modifications, equivalents and alternatives falling within the spirit and technical scope of the present disclosure.

Unless otherwise defined, all terms used herein, including technical or scientific terms, have the same meaning as commonly understood by those skilled in the art to which the present disclosure pertains. The terms such as those defined in commonly used dictionaries should be interpreted as having meanings consistent with meanings in the context of related technologies and should not be interpreted as ideal or excessively formal meanings unless explicitly defined in the present specification.

Hereinafter, the present disclosure will be described in detail through description of preferred embodiments of the present disclosure with reference to the accompanying drawings. Like reference numerals indicated in the respective drawings refer to like members.

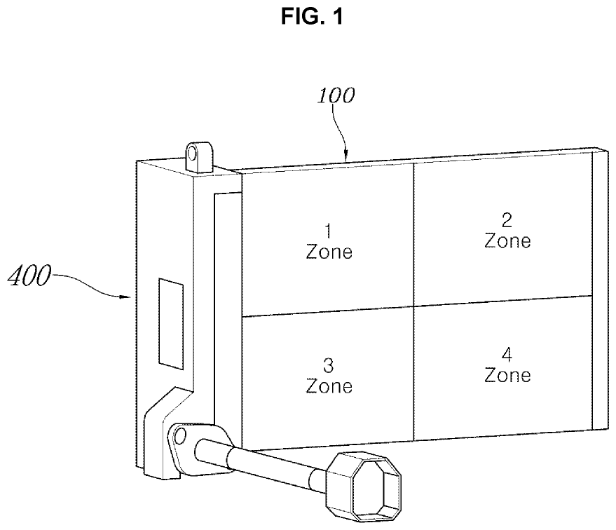

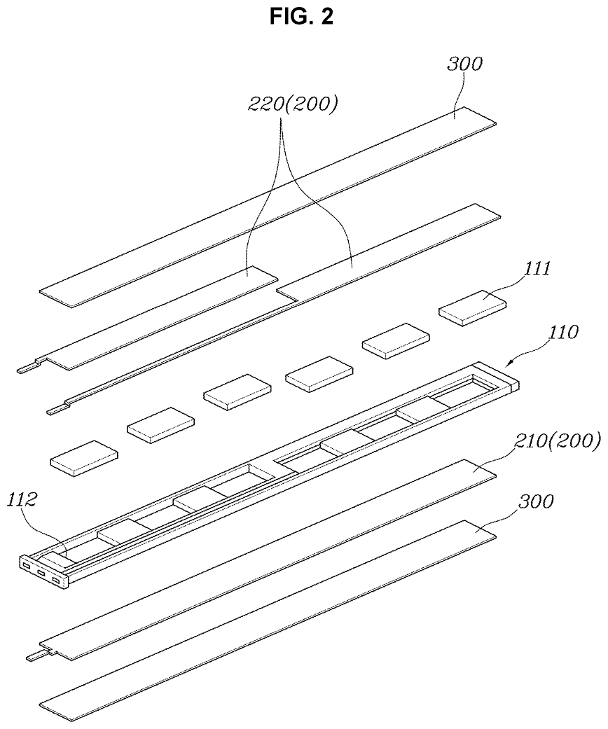

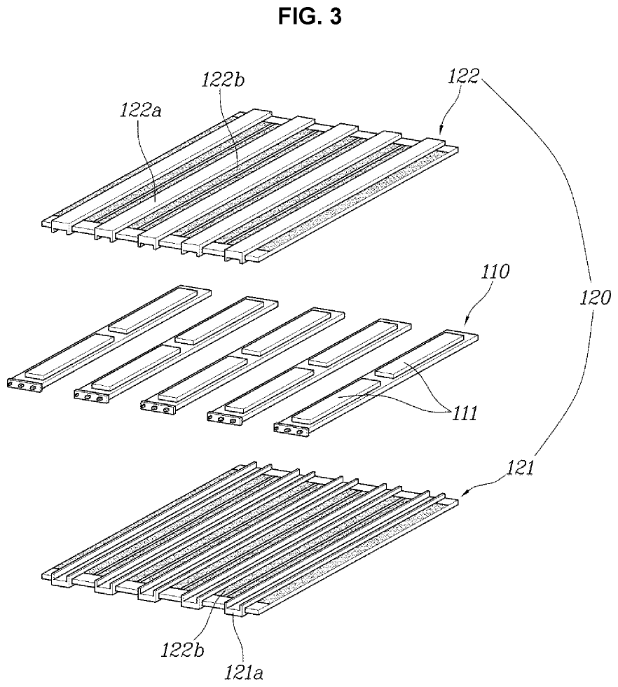

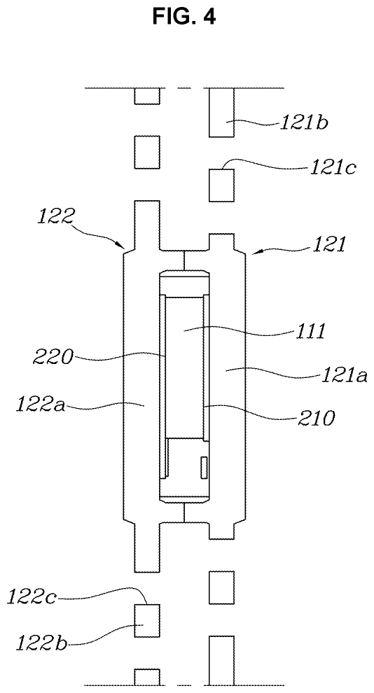

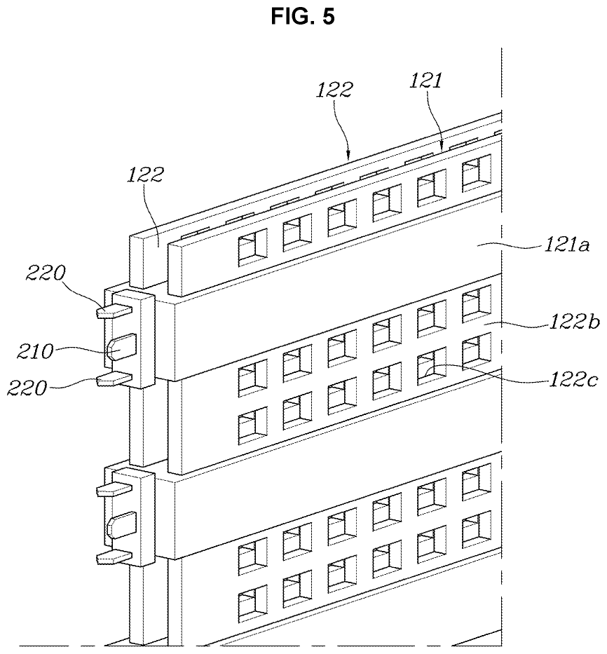

FIG. 1 is a view illustrating a split heater apparatus according to the present disclosure, FIG. 2 is a view illustrating a frame and an electrode plate of the split heater apparatus illustrated in FIG. 1, FIG. 3 is an exploded view of the split heater apparatus illustrated in FIG. 1, FIG. 4 is a cross-sectional view of the split heater apparatus illustrated in FIG. 1, and FIG. 5 is a view illustrating a first heat radiating plate and a second heat radiating plate of the split heater apparatus illustrated in FIG. 1.

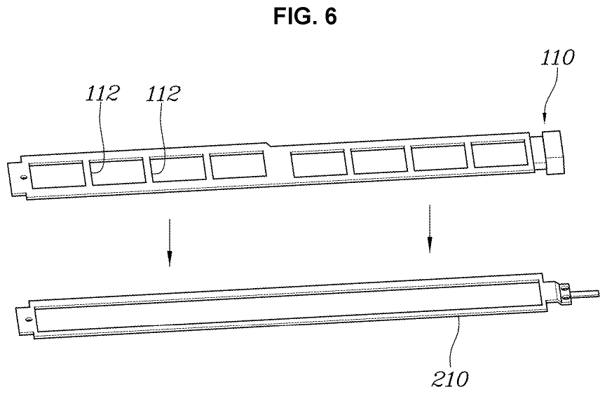

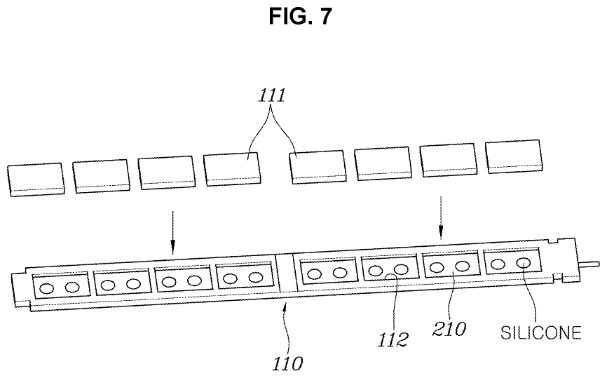

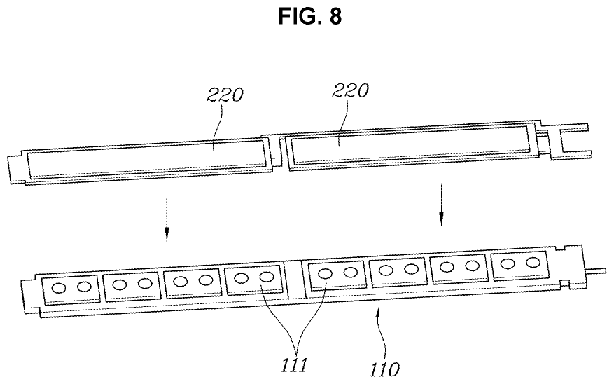

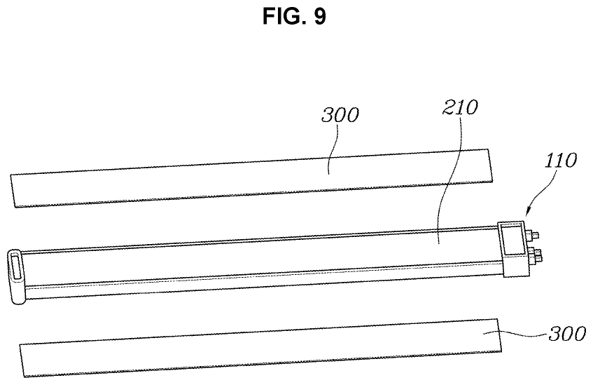

Meanwhile, FIG. 6 is a view for explaining a first step of a method of manufacturing the split heater apparatus, FIG. 7 is a view for explaining a second step of the method of manufacturing the split heater apparatus, FIG. 8 is a view for explaining a third step of the method of manufacturing the split heater apparatus, and FIG. 9 is a view for explaining fourth and fifth steps of the method of manufacturing the split heater apparatus.

As illustrated in FIGS. 1 to 4, the split heater apparatus according to the present disclosure includes a heat radiating unit 100 including a frame 110 configured to accommodate a plurality of heat generating elements 111, and a heat radiating plate 120 configured to radiate heat generated by the heat generating elements, and a plurality of electrode plates 200 respectively joined to two opposite surfaces of the frame 110 and configured to apply power to allow the heat generating elements 111 to generate heat.

In this case, the heat radiating unit 100 may be configured such that the frame 110 and the heat radiating plate 120 are integrated. That is, in the heat radiating unit 100, the heat generating elements 111 are accommodated in the frame 110, and the heat radiating plate 120 is integrated with the frame 110, such that the heat may be transferred to the frame 110 and the heat radiating plate 120 and radiated when the heat generating elements 111 operate. In addition, the frame 110 is configured to be embedded in the heat radiating plate 120, such that damage to the heat generating element 111 is prevented, and packaging is advantageously performed. A fin structure for efficiency radiating the heat may be provided on the heat radiating plate 120.

Meanwhile, the electrode plate 200 includes a first electrode plate 210 disposed at one side of the heat generating elements 111 and configured to adjoin all of the plurality of heat generating elements 111, and a plurality of second electrode plates 220 disposed at the other side of the heat generating elements 111 and separated to adjoin some of the heat generating elements 111 for respective heating regions.

The heat generating element 111 is a positive temperature coefficient (PTC) element. The plurality of heat generating elements 111 is accommodated and fixed in the frame 110. The frame 110 may be made of an insulating material and extend rectilinearly. The plurality of frames 110 may be coupled to constitute a heater apparatus having a predetermined area.

In particular, the frame 110 has a plurality of seating holes 112 opened at two opposite sides thereof and configured such that the heat generating elements 111 are seated in the seating holes 112. The seating hole 112 is identical in shape to the heat generating element 111. The seating holes 112 are spaced apart from each other at predetermined intervals in a longitudinal direction. The heat generating elements 111 are accommodated and fixed in the seating holes 112. In particular, the seating holes 112 disposed in the frame 110 are separated for respective heating regions and have height deviations. That is, in the related art, PTC elements are arranged rectilinearly at the same height, and all the PTC elements simultaneously operate, and an overall area of the entire heater apparatus generate heat. According to the present disclosure, the heat generating elements 111 are disposed in a stepped manner in the frame 110 and have the height deviations. Therefore, the heat generating elements 111 may be separated for the respective heating regions and heat the zones individually. That is, at the time of coupling, to the frame 110, the second electrode plates 220 of the electrode plate 200 which are separated for the respective heating regions, the second electrode plates 220 may be separated and coupled for the respective height deviations, and the second electrode plates 220 are connected to one another, thereby preventing interference of an electric field.

In the present disclosure, the electrode plate 200 includes the first and second electrode plates 210 and 220 configured to respectively adjoin the two opposite surfaces of the frame 110. The first and second electrode plates 210 and 220 each have an electrode terminal and apply power to the heat generating elements 111 to allow the heat generating elements 111 to generate heat. In particular, the plurality of second electrode plates 220 may be separated for the respective heating regions, such that the heat generating element 111 may each generate heat for each of the heating regions. That is, the first electrode plate 210 has a ‘-’ electrode terminal, and the second electrode plate 220 has a ‘+’ electrode terminal. The power may be applied to the respective second electrode plates 220, such that the heat generating elements 111 may generate heat for the respective heating regions.

Meanwhile, the split heater apparatus may further include insulation members 300 configured to adjoin the outer sides of the first and second electrode plates 210 and 220 and insulate the first and second electrode plates 210 and 220. The insulation members 300 are respectively bonded to outer surfaces of the first and second electrode plates 210 and 220 and fix the first and second electrode plates 210 and 220 so that the first and second electrode plates 210 and 220 are not separated from the frame 110.

Meanwhile, as illustrated in FIG. 3, the heat radiating plate 120 may include: a first heat radiating plate 121 having first accommodation portions 121a disposed at one side of the frame 110 and configured to accommodate a part of the frame 110 and the first electrode plate 210, and first heat radiating parts 121b extending from the first accommodation portions 121a and having a plurality of first vent holes 121c; and a second heat radiating plate 122 having second accommodation portions 122a disposed at the other side of the frame 110 and configured to accommodate a part of the frame 110 and the second electrode plate 220, and second heat radiating parts 122b extending from the second accommodation portion 122a and having a plurality of second vent holes 122c.

The first and second heat radiating plates 121 and 122 are separably coupled with respect to the frame 110 and the electrode plate 200, such that the ease of assembling and maintenance may be improved.

In addition, the first and second heat radiating plates 121 and 122 may be made of an aluminum material and assembled to face each other, such that the frame 110, the first electrode plate 210, and the second electrode plate 220 are embedded in the first and second accommodation portions 121a and 122a.

In this case, the first heat radiating plate 121 has the first heat radiating parts 121b having the plurality of first vent holes 121c, such that the heat generated by the heat generating elements 111 may be transferred to the first heat radiating parts 121b and exchange heat with air flowing through the first vent holes 121c, thereby producing heating air. The second heat radiating plate 122 has the second heat radiating parts 122b having the plurality of second vent holes 122c, such that the heat generated by the heat generating elements 111 may be transferred to the second heat radiating parts 122b and exchange heat with air flowing through the second vent hole 122c, thereby producing heating air.

In addition, when the first and second heat radiating plates 121 and 122 are coupled to each other, the first vent holes 121c and the second vent holes 122c are alternately disposed. As illustrated in FIGS. 4 to 5, the first vent holes 121c of the first heat radiating plate 121 and the second vent holes 122c of the second heat radiating plate 122 are alternately disposed instead of facing one another, such that heat exchange efficiency is improved between the air passing through the first and second vent holes 121c and 122c and the first and second heat radiating parts 121b and 122b.

Meanwhile, the first heat radiating plate 121 has the plurality of first accommodation portions 121a and the plurality of first heat radiating parts 121b that are alternately disposed. The second heat radiating plate 122 has the plurality of second accommodation portions 122a and the plurality of second heat radiating parts 122b that are alternately disposed. When the first and second heat radiating plates 121 and 122 are coupled, the frames 110 and the electrode plates 200 are accommodated in the first and second accommodation portions 121a and 122a.

This is to ensure a heat exchange area through the first and second heat radiating plates 121 and 122. The first accommodation portions 121a and the first heat radiating parts 121b of the first heat radiating plate 121 and the second accommodation portions 122a and the second heat radiating parts 122b of the second heat radiating plate 122 may be sequentially and alternately disposed, thereby increasing the area for the heating regions. In addition, the frame 110 and the electrode plate 200 are provided for each of the plurality of first and second accommodation portions 121a and 122a, such that the plurality of first heat radiating parts 121b and the second heat radiating parts 122b may generate heat.

Meanwhile, a control module 400 (FIG. 1) may be connected to the first and second heat radiating plates 121 and 122. The control module 400 may be connected to the first and second electrode plates 210 and 220, such that the heat generating elements 111 may generate heat depending on whether the power is applied. A PCB substrate, an IGBT, and a heat sink may be provided in the control module 400. The first electrode plate 210 and the plurality of second electrode plates 220 may be respectively connected to the control boards. Therefore, the control module 400 may receive a command required to produce the heating air and apply power to the second electrode plates 220 for the respective heating zones, such that the heat generating elements 111 supplied with power through the second electrode plates 220 may individually generate the heat.

Therefore, the first and second heat radiating plates 121 and 122 according to the present disclosure may ensure the heat radiating area. Further, the power is individually applied to the second electrode plates 220 embedded in the first and second accommodation portions 121a and 122a, such that the heat may be radiated for the respective separated heating regions. Therefore, as illustrated in FIG. 1, the split heater apparatus according to the present disclosure may include four heating zones and generate heat for the respective heating zones independently, such that the heating is efficiently is performed, and the amount of electric power is reduced when the heating is performed.

Meanwhile, the split heater apparatus according to the present disclosure may be manufactured by the following process.

As illustrated in FIG. 6, the method of manufacturing the split heater apparatus includes a first step of assembling the first electrode plate 210 to one side of the frame 110. In this case, the first electrode plate 210 has the ‘-’ electrode terminal, and the first electrode plate 210 is assembled and fixed to the frame 110.

Thereafter, as illustrated in FIG. 7, the method includes a second step of applying an adhesive and coupling the plurality of heat generating elements 111 to the frame 110. That is, the plurality of heat generating elements 111 is connected to the frame 110 assembled to the first electrode plate 210. The seating holes 112 are formed in the frame 110 so that the heat generating elements 111 may be seated in the seating holes 112. The adhesive is applied in the seating holes 112 to bond the heat generating elements 111 to the seating hole 112 of the frame 110, such that the heat generating elements 111 seated in the seating holes 112 are fixed. In this case, the adhesive may be silicone.

Thereafter, as illustrated in FIG. 8, the method includes a third step of assembling the plurality of second electrode plates 220 to the other side of the frame 110. In this case, the second electrode plate 220 has the ‘+’ electrode terminal. The second electrode plate 220 is provided in plural, and the plurality of second electrode plates 220 is assembled and fixed to the frame 110 so that the plurality of second electrode plates 220 is not in contact with one another.

Further, when the first electrode plate 210, the second electrode plate 220, and the heat generating elements 111 are coupled to the frame 110, a fourth step of pressing the first electrode plate 210, the second electrode plate 220, and the heat generating elements 111 and curing the adhesive is performed. As illustrated in FIG. 9, the method includes a fifth step of attaching the insulation members 300 to the outer surfaces of the first and second electrode plates 210 and 220. Therefore, one heating rod may be manufactured.

Therefore, according to the present disclosure, a silicone injection molding process for coupling the electrode plate 200 and the frame 110 in the related art is eliminated. Therefore, it is possible to solve the problem of the smell of silicone produced when the PTC element generates heat. In addition, according to the present disclosure, the heating region is divided into the zones, the zones are heated individually, and the components are simply assembled, such that the number of components and the number of assembly processes are reduced.

While the specific embodiments of the present disclosure have been illustrated and described, it will be obvious to those skilled in the art that the present disclosure may be variously modified and changed without departing from the technical spirit of the present disclosure defined in the appended claims.

1. A split heater apparatus comprising:
a heat radiating unit including:
a frame configured to accommodate a plurality of heat generating elements, and a heat radiating plate configured to radiate heat generated by the heat generating elements; and
a plurality of electrode plates joined to opposite surfaces of the frame, and the plurality of electrode plates being configured to apply power to allow the plurality of heat generating elements to generate the heat;
wherein the plurality of electrode plates comprises:
a first electrode plate positioned at one side of the plurality of heat generating elements and configured to adjoin all of the plurality of heat generating elements; and
a plurality of second electrode plates disposed at an other side of the plurality of heat generating elements, and being separated to adjoin some of the plurality of heat generating elements for respective heating regions.

2. The split heater apparatus of claim 1, wherein the frame and the heat radiating plate are integrated, and the frame is embedded in the heat radiating plate.

3. The split heater apparatus of claim 1, wherein the frame has a plurality of seating holes opened at two opposite sides, and wherein the plurality of heat generating elements are seated in the plurality of seating holes; and
wherein the plurality of seating holes are separated for the respective heating regions and have different heights.

4. The split heater apparatus of claim 1, further comprising:
insulation members configured to adjoin outer sides of the first and second electrode plates and to insulate the first and second electrode plates.

5. The split heater apparatus of claim 1, wherein the heat radiating plate comprises:
a first heat radiating plate; and
a second heat radiating plate;
wherein the first heat radiating plate comprises a first accommodation portion positioned at one side of the frame and configured to accommodate a part of the frame and the first electrode plate, and a first heat radiating part extending from the first accommodation portion and having a plurality of first vent holes; and
wherein the second heat radiating plate comprises a second accommodation portion positioned at an other side of the frame and configured to accommodate a part of the frame and the second electrode plate, and a second heat radiating part extending from the second accommodation portion and having a plurality of second vent holes.

6. The split heater apparatus of claim 5, wherein the first and second heat radiating plates are coupled to the frame and to the plurality of electrode plates.

7. The split heater apparatus of claim 5, wherein the first and second vent holes are alternately disposed when the first and second heat radiating plates are coupled to each other.

8. The split heater apparatus of claim 5, wherein the first heat radiating plate comprises a plurality of first accommodation portions and a plurality of first heat radiating parts that are alternately disposed,
wherein the second heat radiating plate comprises a plurality of second accommodation portions and a plurality of second heat radiating parts that are alternately disposed, and
wherein the frame and the plurality of electrode plates are accommodated in the first and second accommodation portions when the first and second heat radiating plates are coupled.

9. The split heater apparatus of claim 8, wherein the first and second heat radiating plates have a plurality of heating zones as power is applied to each of the second electrode plates individually.

10. The split heater apparatus of claim 5, further comprising:
a control module connected to each of the first and second electrode plates, the control module being configured to determine whether to apply power.

11. A method of manufacturing the split heater apparatus according to claim 1, the method comprising:
assembling a first electrode plate to one side of a frame;
coupling a plurality of heat generating elements to one side of the frame by applying an adhesive;
assembling a plurality of second electrode plates to an other side of the frame;
pressing the first electrode plate, the second electrode plate, and the heat generating elements against the frame and curing the adhesive; and
attaching insulation members to outer surfaces of the first and second electrode plates.
